(19) United States
(12) Patent Application Publication
(10) Pub. No.: US 2009/0279532 A1
(43) Pub. Date: Nov. 12, 2009

(54) TCP/IP BASED VOICE COMMUNICATION SYSTEM

(75) Inventors: William L. Perna, Las Vegas, NV (US); Vicki Crowder, Las Vegas, NV (US)

Correspondence Address: KNOBBE MARTENS OLSON & BEAR LLP, 2040 MAIN STREET, FOURTEENTH FLOOR, IRVINE, CA, 92614, US

(73) Assignee: CUSTOM TELECONNECT, INC., Las Vegas, NV (US)

(21) Appl. No.: 12/116,135

(22) Filed: May 6, 2008

(51) Int. Cl. H04L 12/50; H04M 7/00

(52) U.S. Cl. 370/352; 379/220.01

(57) ABSTRACT

In various embodiments described herein a TCP/IP based voice communication system is described. The TCP/IP based voice communication system may be useful in a correctional facility or other environments such as college campus, hospitals or other institutions. In addition to providing voice communication from a source to a destination, the voice communication system can perform additional functions for example, validating destination numbers, maintaining user records and storing call details.

### BACKGROUND

1. Field of the Invention

This invention relates in general to the field of voice communication networks and in particular to the design, system and method of connecting two voice communicating devices over the network.

2. Description of the Related Art

In the Public Switched Telephone Network (PSTN), residential and commercial telephones in a geographical area were connected to a local telephone exchange. Several local telephone exchanges were connected together with trunk lines. Analog signals and mechanical switches were used for providing voice communication between source and destination in the PSTN. Over the years with growth in technology, PSTN has evolved from an analog communication network with mechanical switches to a digital communication network including a variety of switching and signaling techniques.

### SUMMARY

Voice communication systems in correctional facilities may have additional requirements concerning security and providing connectivity. For example, in a correctional facility, it may be useful to keep track of the phone numbers to which calls are placed, the number of calls made by a particular inmate, the number of calls placed to a particular phone number, the dollar amount of the calls placed by a particular inmate and other such details. It may also be advantageous in such communication systems to have the ability to record conversations that can be legally recorded. It may be beneficial if these services can be provided at lower cost.

Generally service providers to correctional facilities have systems and equipments at the correctional facility that will perform some or all the functions listed above before connecting the inmate to the outside telephone number. The cost of provisioning and maintaining the systems at individual correctional facility can rapidly increase. Thus there is a need for an architecture that has systems at a few locations that can monitor, validate and connect calls from multiple correctional facilities. Further it may be advantageous if systems and devices at one or more correctional facilities can be provisioned, controlled and maintained from these locations. In one embodiment, the provisioning, controlling and maintaining can be performed using a web interface.

In one embodiment, a system for providing voice connection between a user at a source location and a destination is disclosed. The system comprises a plurality of telephone adapter devices configured in a first local area network, a plurality of voice communication devices in communication with said telephone adapter devices and a router in communication with the first local area network and an IP network. The system further comprises a plurality of processing centers in communication with the IP network and the public switched telephone network. Each of the plurality of processing centers comprise at least one server in communication with said plurality of voice communication devices over the IP network and said at least one server can exchange information with the user at the correctional facility, process the information exchanged and based on the processing result, establish communication between the user and the destination.

In one embodiment, a method of providing voice communication from a user at a source location to a receiver at a destination is disclosed. The method comprises providing at the source location a plurality of telephone adapter devices configured in a first local area network and a router, wherein said router is in communication with the plurality of telephone adapter devices at a first end and in communication with a IP network at a second end. The method further comprises providing a plurality of processing centers in communication with the IP network, each of said plurality of processing centers comprising at least one server. The method also comprises providing a plurality of voice communication devices in communication with the plurality of telephone adapter devices, wherein the plurality of telephone adapter devices convert signals from the voice communication devices into signals that can be transported over the IP network. Additionally, the method comprises establishing communication between one of the voice communication devices and one of the plurality of processing centers by converting signals from the voice communication devices into signals that can be transported over the IP network and converting signals that can be transported over the IP network into signals that can be processed by the voice communication devices. The method further comprises processing at said one of the plurality of processing centers, the information received from the voice communication devices and establishing communication between one of the said voice communication devices and the receiver at a destination through said one of the plurality of processing centers on the basis of the processing results.

### BRIEF DESCRIPTION

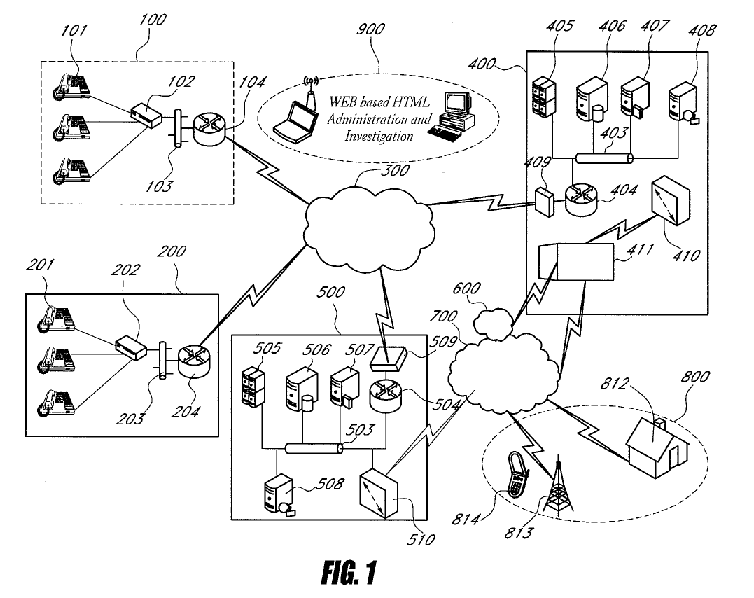

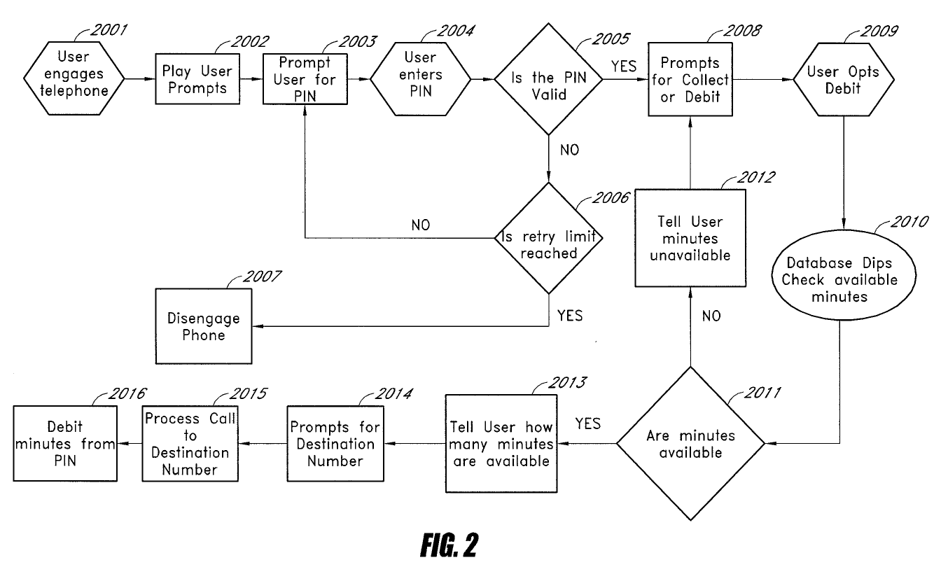

FIG. 1 illustrates an embodiment of a voice communication system to provide voice connection from source to destination.

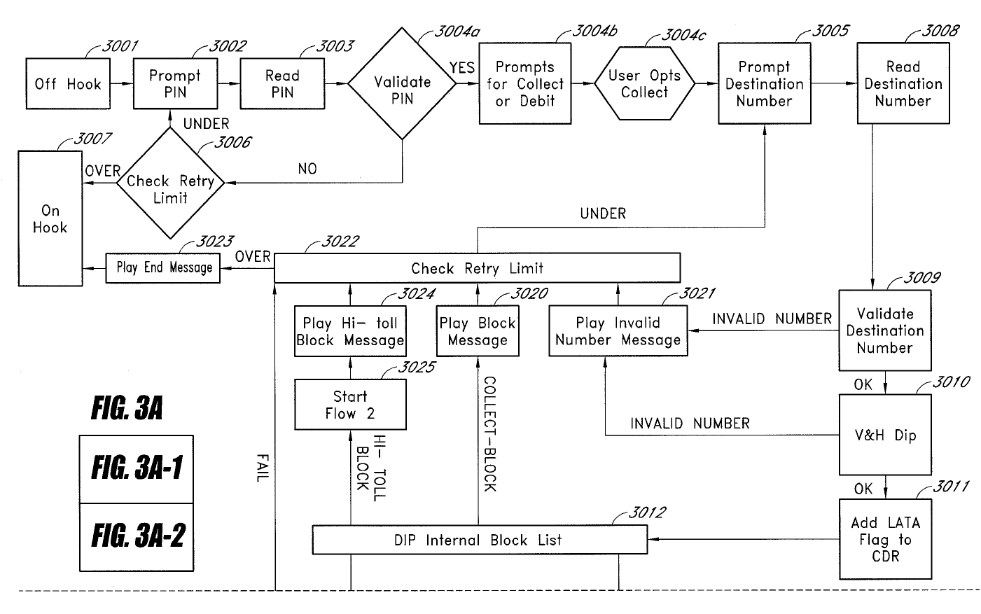

FIG. 2 is a flow chart illustrating a process of placing calls in one embodiment of the system.

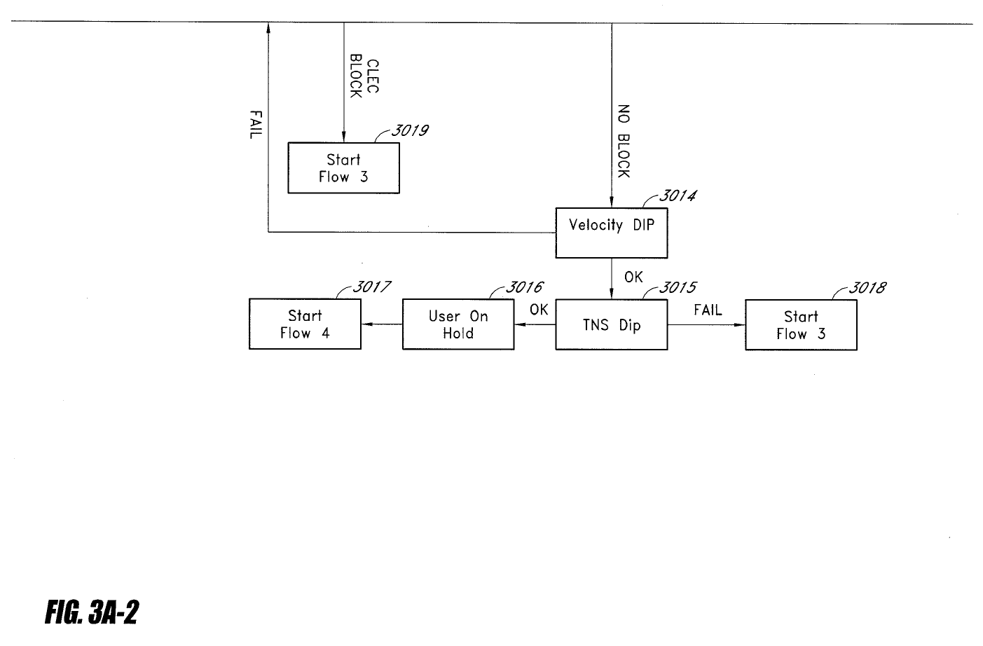

FIG. 3A is a flow chart illustrating a process of placing calls to an external destination number in one embodiment of the system.

FIG. 3B is a flow chart illustrating the steps performed in the process of placing calls if a destination number is blocked due to high toll in one embodiment of the system.

FIG. 3C is a flow chart illustrating the steps performed in the process of placing calls if a destination number is blocked in one embodiment of the system.

FIG. 3D is a flow chart illustrating the process of establishing connection with a destination number upon validation in one embodiment of the system.

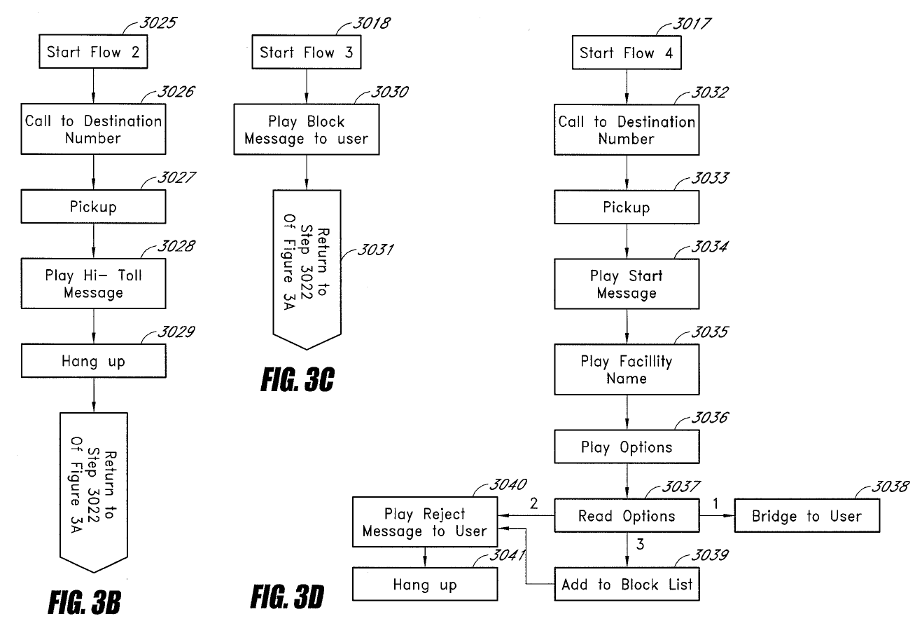

FIG. 4 illustrates an example of a web page that can be used by a customer or an administrator at a facility.

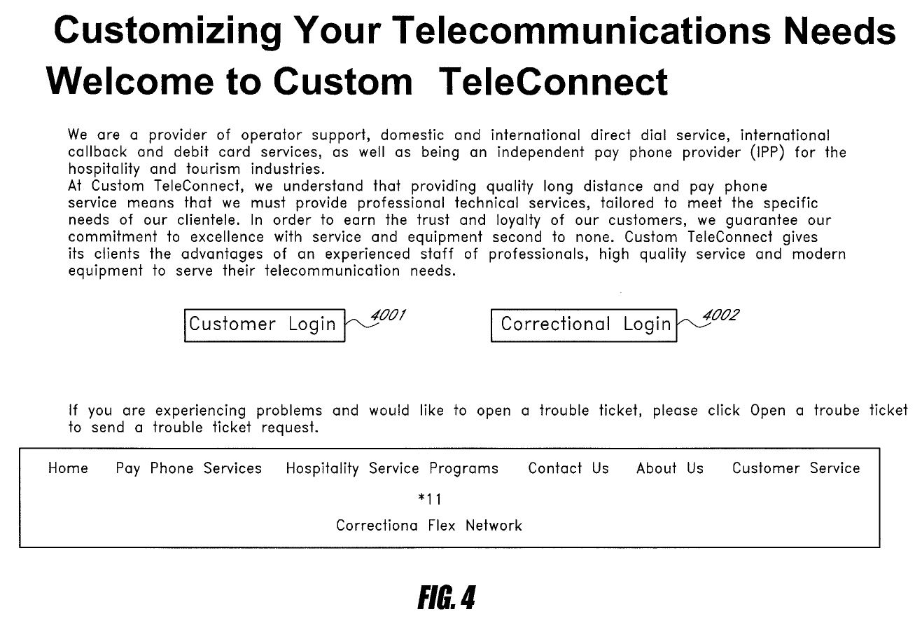

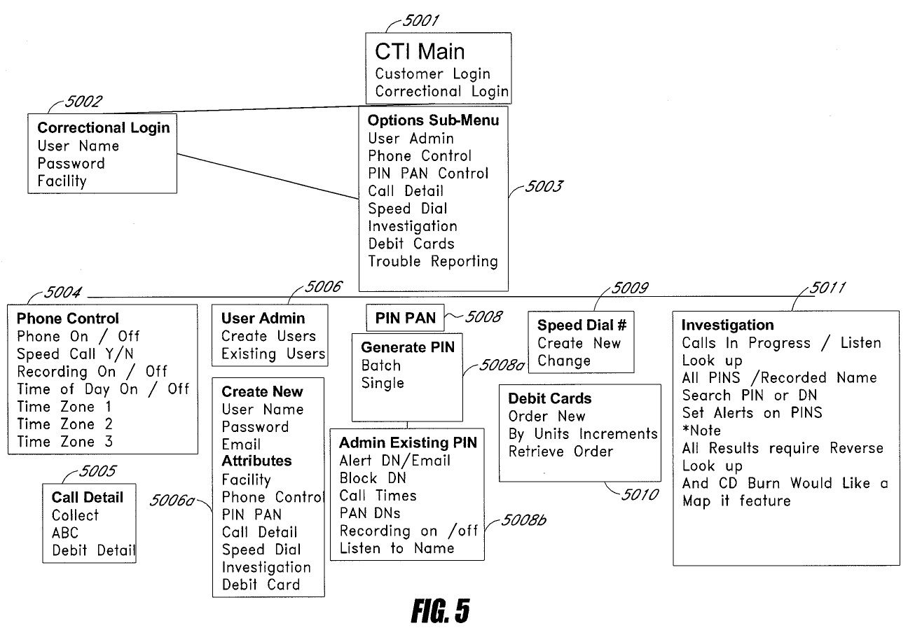

FIG. 5 illustrates an example of menus and sub-menus that can be accessed by the customer or administrator to perform service functions.

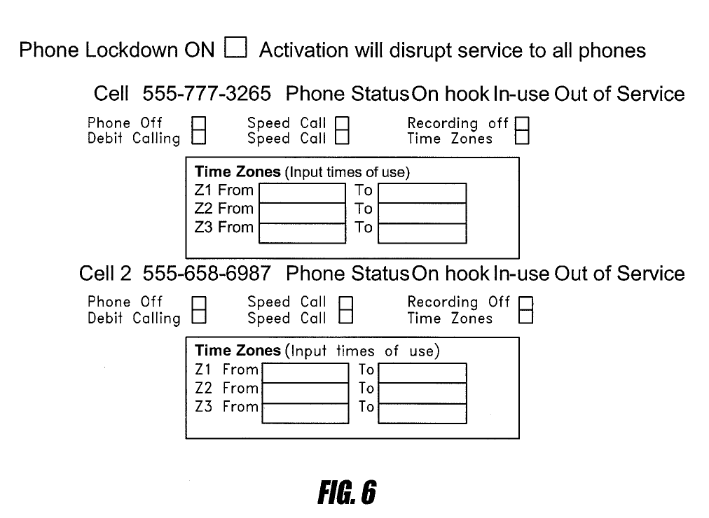

FIG. 6 illustrates one embodiment of a phone control sub-menu.

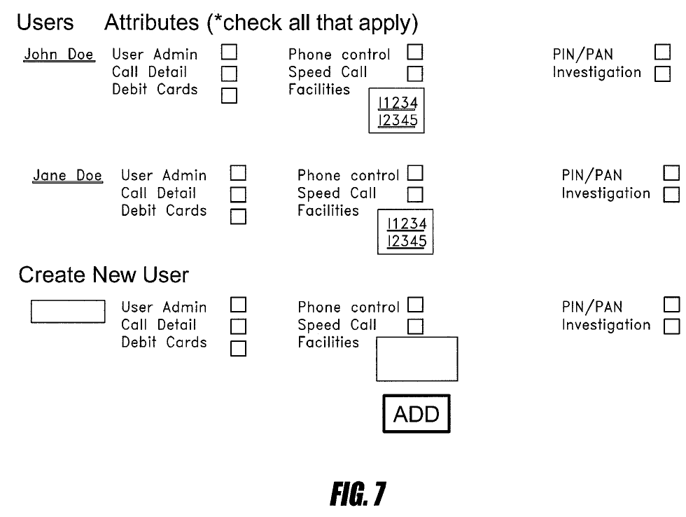

FIG. 7 illustrates one embodiment of a user admin sub-menu.

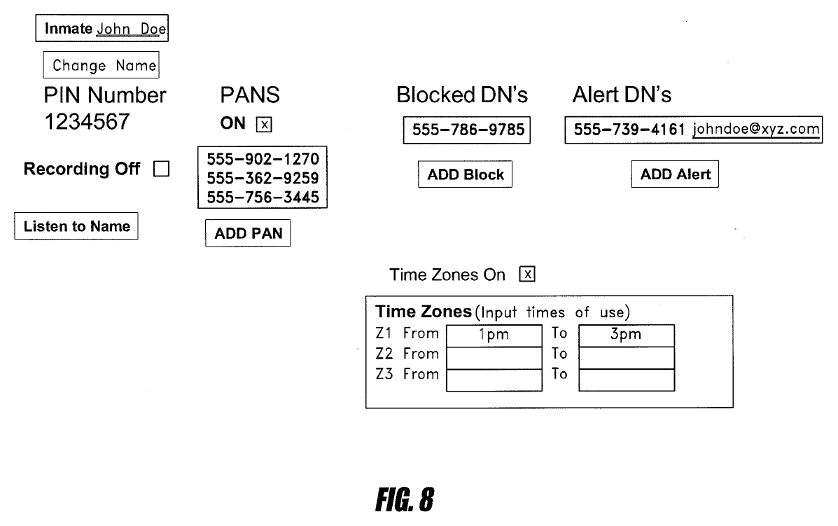

FIG. 8 illustrates one embodiment of a PIN/PAN admin sub-menu

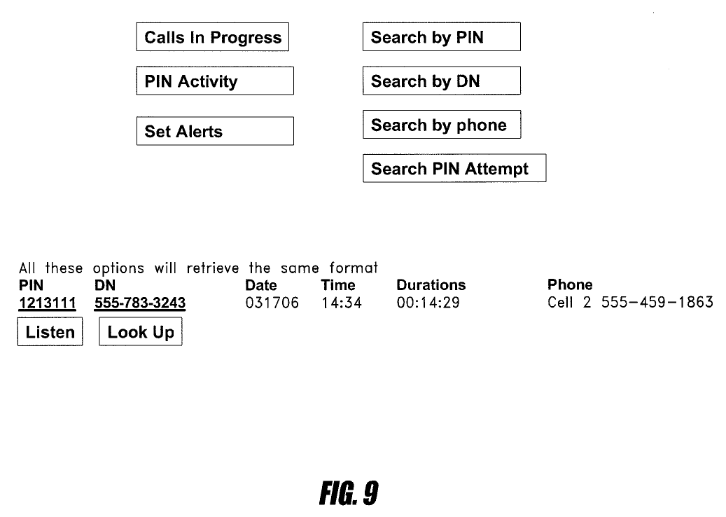

FIG. 9 illustrates one embodiment of an investigation sub-menu.

### DETAILED DESCRIPTION

The following detailed description is directed to certain specific embodiments of the invention. However the invention can be embodied in multiple ways. As will be apparent from the following description even though the invention is described in reference to correctional facilities, the embodiments described herein can be applied in other environments not limited to university/college campus, hospitals, military bases, schools, hotels and business organizations.

FIG. 1 shows an example of a voice communication system that provides connectivity from a source to its destination. Calls originating from a user at a source location having a phone system, such as a correctional facility 100 (or 200) are transported to a processing center 400 (or 500) (e.g. a regional network hub) over an IP network 300. The processing center 400 (or 500) may validate the incoming calls, identify the source and destination of the incoming call, identify the billing status of the incoming calls, make decision as to whether the incoming call should be routed to the destination and find an optimum method and route to forward the call to its destination. Upon making the decision to forward the call to its destination and finding the optimal method and route to forward the call to its destination, the processing center 400 (or 500) may forward the call over another TCP/IP network or over the Public Switched Telephone Network (PSTN) to its destination. The destination can be a terrestrial telephone located in a residence 812, a wireless device 814 or other telephone system. Upon establishing voice communication, the processing center 400 (or 500) may additionally perform real time monitoring of the call, record the conversation and prepare billing statements. The processing center 400 (or 500) may perform all or some of the functions listed above. In some embodiments, the processing center 400 (or 500) may have additional capabilities not mentioned herein. Additional details about the systems and methods used to provide connectivity in the manner described above are disclosed in the following paragraphs.

Processing centers 400 (or 500) may be placed at a few locations. For example, a processing center 400 may be located in Las Vegas, Nev. and another processing center 500 may be located in New York, N.Y. The processing center 400 (or 500) may range in complexity and functionality. For example, small processing centers with limited functionality and complexity may be placed within the system. The processing center 400 (or 500) can include most of the call processing equipment. The processing center 400 (or 500) may communicate with the TCP/IP network 300 via a router 404 (or 504), gateway device 410 (or 510) or a switch device. Additionally the processing center 400 (or 500) can also connect with the traditional Public Switched Telephone Network (PSTN) 700 over a circuit or TDM switch such as a Class 4 Tandem Switch 411. In some embodiments, the processing center 400 (or 500) may connect to the PSTN via a Switch Termination Point (STP) 600, a circuit switch 411 or both. The processing center 400 (or 500) can include at least one or all of the following sub-systems: a voice server 405 (or 505), a storage server 406 (or 506), a firewall server 407 (or 507), an application server/web server 408 (or 508). These systems can be in communication with each other over a local area network (LAN) 403 (or 503). In one embodiment, a single system may be used as a voice server, a web server, a proxy server, a storage server and a firewall server.

The application/web server 408 (or 508) provides a software platform that delivers content to the World Wide Web (WWW). The application/web server 408 (or 508) can also receive and interpret instructions and information from the WWW and use the same to update databases, provision and control the various sub-systems and components of the network described in FIG. 1. Thus the application/web server 408 (or 508) provides means of provisioning, maintaining, updating, controlling and administering the various sub-systems of the communication system illustrated in FIG. 1 remotely using the WWW. The application server can be in communication with the voice server, the storage server, the firewall server 407 within the network hub 400 (or 500) over the LAN 403 (or 503). The application server can also be in communication with other processing centers, the source locations, the IP network and the PSTN via the router 404 (or 504) or the IP gateway 410 (or 510) or both. In some embodiments, the application/web server can include a proxy server to validate the incoming traffic to the processing center.

The voice server 405 (or 505) can be configured to run Asterisk®, which is an open source software implementation of a telephone private branch exchange (PBX). Other open source or licensed software telephony platforms can be used instead of Asterisk®. The voice server 405 (or 505) running an open source or licensed software telephony platform can be configured to allow a plurality of telephone adapter device (e.g. analog telephone adapters) or digital telephone to be connected to it. The voice server 405 (or 505) can allow communication between the plurality of telephones connected to the server and also to connect to other telephone devices connected to the PSTN. Additionally, the voice server 405 (or 505) can provide features such as voice mail, custom salutations, option to choose languages, language prompts, interactive voice response, custom menus, conference calling, automatic call distribution, etc. New functionalities and features can be created by writing scripts and codes in Asterisk's own language or by adding custom modules written in other scripting or programming languages such as Perl or C.

In the system illustrated in FIG. 1, the voice server 405 (or 505) can be provided with validation databases obtained from the consortium of telephone providers and/or compiled by the service provider. The voice server 405 (or 505) may also be provided with other internal database. The validation database can be used to verify the identity and the account balance of the user, verify the existence of a dialed number, confirm whether the dialed number is associated with a switch-less service provider or associated with a competitive local exchange carrier (CLEC), verify whether the account status of the dialed number is in good standing, etc. The internal databases can keep a record of the number of attempts and connections made to a specific number, the dollar amount billed to a specific phone number, etc. The validation and internal databases can be updated hourly, daily, weekly or monthly. The update of the validation and internal databases can be performed by the application/web server 408 (or 508) from a remote location over the WWW.

The processing center 400 (or 500) can also include a storage server 406 (or 506) which provides access and control to a storage network. The storage server 406 (or 506) can be in communication with the other components and sub-systems of the network hub 400 (or 500) and the IP network 300 through the LAN 403 (or 503). The storage server 406 (or 506) can be provided to store the call details and the billing information about the call. The storage server 406 or (506) can be accessed internally by the voice server 405 (or 505) or by the application server 408 (or 508). In addition the storage server 406 (or 506) can also be accessed from outside the network hub 400 (or 500) through the application server 408 (or 508). The application server 408 (or 508) can be configured to provide different levels of security so that information from the storage server 406 (or 506) that is in public domain can be accessed by all whereas information that is confidential and subject to privacy laws or some other privacy obligation such as attorney-client privilege, is only accessed by those authorized to do so.

The processing center 400 (or 500) can be provided with a firewall server 407 (or 507). The firewall server 407 (or 507) manages a firewall 409 (or 509) that is configured to allow valid and authenticated traffic from and into the network hub 407 (or 507). Examples of valid traffic include requests from the WWW to access information that is in the public domain, incoming traffic from other processing centers such as 500 (or 400), incoming traffic from the source locations that are being provided service such as 100 or 200, information sent to the application server from a validated source over the WWW to update voice server or access storage networks, etc. The firewall 409 (or 509) can be a hardware device or a software program that is configured to filter and direct valid traffic into the network hub 400 (or 500). The firewall server 407 can be standalone or be in communication with the LAN 403 (or 503). In some embodiments, the firewall server 407 can be administered by the application/web server 408 (or 508).

In one embodiment, the processing center 400 (or 500) can communicate with the IP network through a router 404 (or 504). The router 404 (or 504) can include IP routers. The router 404 (or 504) can receive Internet packets from the IP network and forward those packets intended for the network hub to the application/web server 408 (or 508) for further processing. For example, upon receiving a call request from the source, the router can forward the call request to the application/web server 408 (or 508). The application/web server 408 (or 508) and the voice server 405 (or 505) can perform the steps required to validate the call request. While performing the validation steps, information from the source may be required by the application/web server 408 (or 508), the router 404 (or 504) can forward the request for information from the application/web server 408 (or 508) to the source and forward the response to the information request from the source to the destination.

The decision to establish connection between the source and the destination is made by the processing center 400 (or 500) based on the results or outcome of the validation process. After the decision to establish connection between the source and the destination is made, the call is forwarded to the destination by the application/web server 408 (or 508) to the destination through an IP gateway device 410 (or 510). The IP gateway device 410 (or 510) provides connection between an IP-based network such as the IP network and a circuit-switched network such as the PSTN 700. The PSTN 700 comprises residential telephones serviced by CLECs. In some embodiments, the PSTN 700 may interface with one or more wireless networks 813. The IP gateway device 410 (or 510) can also provide signaling, connectivity and translation of traditional voice communications across an IP-based network to another IP Gateway device. In some embodiments, the IP gateway device 410 (or 510) can provide the following functions: convert voice-over-IP packets to traditional PSTN method of transporting voice, map telephone numbers to destination IP addresses, convert analog signals into packets and vice versa, etc. The IP Gateway device 410 (or 510) can have line connections for traditional telephone handsets, a trunk tie line connection for other IP Gateway device. It can also have a LAN interface connection and a WAN interface connection. The IP Gateway device 410 (or 510) can be compliant with International Telecommunications Union-Telecommunication Sector's (ITU-T) H.323 body of standards. The IP gateway device 410 (or 510) can include devices from manufacturers such as Quintum Technologies, Cisco or other manufacturers. In some embodiments, the IP gateway device 410 (or 510) can communicate directly with the PSTN. In some other embodiments, the IP gateway device 410 (or 510) can communicate with the PSTN over a circuit-switch (or a TDM device) such as a Class 4 Tandem switch 411. In some embodiments, the IP gateway device 410 (or 510) or the Class 4 tandem switch 411 can interface with the PSTN through a SS7 signaling network 600.

The communication system illustrated in FIG. 1, can be configured to provide voice connectivity to a person having a telephone at a source location 100/200. In one embodiment, the source location 100/200 can be a correctional facility. The source location 100/200 can include one or more voice communication devices 101 (for example, a telephone). The one or more voice communication devices 101 (or 201) can be substantially connected to one or more telephone adapter devices 102 (or 202) (e.g. analog telephone adapter (ATA)). The telephone adapter devices 102 (or 202) can convert analog signals from a traditional calling device, such as a telephone, adapted to connect to the PSTN into voice-over-IP packets. In some embodiments, the telephone adapter devices 102 (or 202) can comprise an IP gateway device. The source location 100/200 can have one or more telephone adapter devices depending on its size. The telephone adapter devices can be configured to be linked to a LAN 103 (or 203). If the number of calling devices in the source location 100/200 is limited then a single telephone adapter device can be deployed without the LAN 103 (or 203). The telephone adapter device 102 (or 202) can be joined or connected to a router, gateway device or a switch device 104 (or 204) directly or through the LAN 103 (or 203). The router, gateway device or the switch device 104 (or 204) provides connectivity from the source location 100/200 to the IP network 300. In some embodiments, a router 104 (or 204) may be used as an entry/exit point for communication traffic (for example, voice) from the source location 100/200. Each telephone adapter device 102 (or 202) can be associated with a media access control (MAC) address and a static IP address.

Each user at the source location 100/200 can have a unique identification number and a unique account. The unique account can exist in a remote server (for example, the application/web server 408 (or 508) or the voice server 405 (or 505)). In some embodiments, the unique account can exist on the Internet and can be identified by a unique account number. A user at the source location 100/200 may have the option of making voice connections in one of two ways; a debit process or a collect process. In some embodiments, a third option of placing calls using a credit card may also be provided. In one embodiment, in the debit process of placing a call, the user's account can be credited with a certain dollar amount via a web interface. The web interface can be configured to allow the user, the user's agent or representative to add prepaid increments to the user's specific account. In some embodiments, the web interface can show the unused minutes associated with the account and not the actual dollar amount. The unused minutes can be determined by dividing the dollar amount credited to the account by the cost of placing the call per minute. The cost of placing the call per minute can be determined by the service provider at the source location 100/200. In some embodiments, a separate web portal that can report revenue or dollar amount on a separate level can be built. In one embodiment, in the collect process of placing a call, the user can place a call even if no unused minutes are available in the person's account. The call can be billed to the destination party. If the user is allowed to place calls using a credit card, then the call is billed to the credit card entered by the user. Each user may be allowed to place only a certain number of calls per 24 hours. For example, if a user selects the collect call method of placing a call, then the user may be allowed to make no more than 4, 6, 8 or 10 attempts at placing a call and no more than 2, 4, 6 or 8 completed calls per 24 hours. In another example, a user using the credit card method of calls may be allowed no more than 2, 4, 6, 8 or 10 attempts at placing a call and no more than 2, 3, 4 or 6 completed calls per 24 hours. In other embodiments the upper limit on the number of attempted and/or completed calls can be different. The upper limit on the number of attempted and/or completed calls can be changed for example, by using a web portal by the customer. In some embodiments, a third party may be allowed to place the call on the user's behalf.

FIG. 2 illustrates the various steps that are followed in establishing voice communication between a source and destination in one embodiment of the system. FIG. 3A-3D illustrates the various steps that are followed in establishing voice communication between a source and destination in another embodiment of the system. A person at a source location 100/200 initiates a call by engaging the voice communication or telephone device 101 (or 201) as illustrated in call initiation step, 2001 of FIG. 2 and call initiation step, 3001 of FIG. 3A. The telephone device 101(or 201) can be engaged in a variety of ways for example, by lifting the handset, pressing a button, or dialing 0. Other ways of engaging the telephone device 101 (or 201) may be used as well. The engaging of the telephone device 101 (or 201) is sensed by the telephone adapter device 102 (or 202). The telephone adapter device 102(or 202) communicates the information that a user wishes to place a call to the router 404 at the network hub 400 or the router 504 at the network hub 500. The decision as to which network hub 400 or 500 to connect to is based on a plurality of factors such as network load, geographical proximity, etc. The incoming information from the telephone adapter device 102 (or 202) is verified by the firewall 409 (or 509), located at the entry/exit point of the network hub 400 (or 500), and forwarded to the router 404 (or 504). The router 404 (or 504) can then forward the call request to the application/web server 408 (or 508).

The application/web server 408 (or 508) can interface with the voice server 405 (or 505) and prompt the person at the source 100/200 to choose a language option. For example, the prompt can be, “Press 1 for English or Press 2 for Spanish.” The user's selection is noted by the application/web server 408 (or 508) and subsequent messages will be in the language selected by the user. Upon language selection, the application/web server 408 (or 508) will interface with the voice server 405(or 505) and prompt the user to enter a personal identification number (PIN). The PIN entered by the user is noted and validated by the application/web server 408 (or 508) or the voice server 405 (or 505). In some embodiments, the PIN provided by the user can be temporarily stored in a memory prior to validation. The processes of prompting the user for choosing a language and entering the identification number are illustrated in the play user prompt step, 2002 and prompt PIN step, 2003 of FIG. 2 and the prompt PIN step, 3002 of FIG. 3A. The next steps in establishing voice communication between source and destination are PIN accepting step, 2004 and PIN validating step, 2005 of FIG. 2A and PIN reading step, 3003 and PIN validating step, 3004a of FIG. 3A. In these steps the PIN entered by the user can be accepted, stored, noted and/or read and validated. Validating the PIN can comprise the step of verifying that the PIN exists in the system. If the PIN entered is invalid then the user can be prompted to reenter the PIN. The number of attempts to enter a valid PIN can be kept track of by the application/web server 408 (or 508). In one embodiment, the number of attempts to enter a valid PIN can be stored in the application/web server 408 (or 508). In one embodiment, after each invalid attempt to enter the PIN, the application server can verify if the number of attempts to enter a valid PIN exceeds a certain maximum number as shown in the retry limit verification step, 2006 of FIG. 2 and retry limit verification step, 3006 of FIG. 3A. In the event that the number of attempts to enter a valid PIN exceeds a certain maximum number (for example, three), a message indicating that the number of attempts is over the limit can be played and the user can be disengaged from the system as illustrated in the call terminating step, 2007 of FIG. 2 and call terminating step, 3007 of FIG. 3A. Upon validation of the identification number or PIN, the user may be prompted to select a method of placing a call as illustrated in call type selection step, 2008 of FIG. 2 and call type selection step 3004b of FIG. 3A. The different methods of placing a call can be: placing collect calls or placing call using a debit card or a credit card. The initial steps involved in placing a call described above can be used in placing collect calls or placing calls using a debit card or a credit card.

Referring to FIG. 2, upon selecting a method of placing a call, for example the user selects placing a call with a debit card, as illustrated in step 2009, the application/web server 408 (or 508) will interface with the voice server 405 (or 505) and locate the account details in an appropriate database as illustrated by database dip step, 2010. The account details can include information such as amount of unused minutes in the account, telephone numbers to which calls can be placed, telephone numbers to which calls cannot be placed etc. In step 2011, the database is accessed to determine if unused minutes are available. If no unused minutes are left in the account, then the user is informed that no minutes are available as illustrated in step 2012 and the process returns to call type selection step, 2008, wherein the user is prompted to select a method of placing a call.

In the event that unused minutes are available, the number of available minutes is communicated to the user as illustrated in step 2013 and the user is prompted for the destination number by the application/web server 408 (or 508) or the voice server 405 (or 505) as illustrated in the destination number prompt step, 2014. In some embodiments, the user may also be prompted at this time to say his or her name. The destination number entered by the user is validated and/or processed in the validation step, 2015. The validation process can comprise at least one or all of the following steps: verifying the existence of the destination number in external databases such as Line Identification Database (LIDB), V&H (vertical and horizontal) database, Operating Company Number (OCN) database and other databases provided by credit card companies, banks or by fraud and validation solution providing companies. As a part of the validation process, positive and negative internal databases or the internal block list located in the application/web server 408 (or 508) or the voice server 405 (or 505) or the storage server 407 (or 507) may be accessed to confirm that the destination number entered by the user is not blocked. If the destination number exists in the internal block list or is unverifiable by the external databases, then the user is notified that the call as dialed cannot be completed. The number of times the user has attempted to place a call is then incremented by 1. If the number of times the user has attempted to place a call is less than the upper limit on the number of attempted calls, the user can be asked to enter a new destination number.

In the event the destination number as dialed by the user does not exist in the block list and/or can be validated, the user is asked to wait while the call is completed and put on hold. While the user is put on hold, the voice server 405(or 505) or the application/web server 408(or 508) can establish a connection to the destination number which can be located on the traditional PSTN or a wireless device located in a wireless network. When the party at the destination answers the phone and completes the connection with the voice server 405 (or 505) or the application/web server 408 (or 508), an announcement of who and where the call is from is played. The called party is given the option to deny, accept or block future call attempts. If the called party blocks future call attempts, then the internal block list in the voice server 405 (or 505) is updated and the user is notified that the call as dialed cannot be completed. The user can be asked to enter a new destination number if the number of attempts made by the user to place a call is less than the upper limit on the number of attempts made by the user to place a call. If the called party denies the call, the user is notified that the call as dialed cannot be completed and can be asked to enter a new destination number if the number of attempts made by the user to place a call is less than the upper limit on the number of attempts made by the user to place a call.

If the called party accepts the call, a connection between the user and the called party is established. The voice-over-IP packets from the source location 100/200 are converted to traditional PSTN method of transmitting voice by the IP gateway device 410 (or 510) and transported over the PSTN to the destination. Minutes are debited from the account of the user from the actual time of acceptance of the call as illustrated on step 2016. In one embodiment, the minutes are rounded off up to the full minute. For example, if the call lasts for 1 minute from the actual time of acceptance of the call then the call time is rounded off to 1 minute. If on the other hand the call lasts for 1.2 minutes from the actual time of acceptance of the call then the call time is rounded off to 2 minutes. In some embodiments, the length of the call can be rounded off up to 2 full minutes. In some embodiments, the length of the call can be rounded off up to 3 full minutes. In some embodiments, the round-off increments could be different including seconds. For example, in some embodiments, the length of the call can be rounded off to 10 seconds, 30 seconds, etc.

The application/web server 408 (or 508) or the voice server 405 (or 505) can monitor the call for the duration of the call. For example, in one embodiment, the voice server 405 (or 505) can keep track of the duration of the call rounded off to the nearest minute and deduct the same from the total number of unused minutes in the user's account. The voice server 405 (or 505) can terminate the call as soon as the call duration rounded off to the nearest minute is equal to the number of unused minutes left in the user's account. In some embodiments, the voice server 405 (or 505) can notify the user when the number of unused minutes in the user's account is one. The voice server 405 (or 505) can also have the capability of recording the conversation. This capability can be useful for security purposes.

After the call is terminated, the voice server 405 (or 505) can forward the call details such as destination number, time of call, duration of the call, identity of the user and the call recording to the storage server. These call details can be accessed at a later time by the application/web server 408 (or 508) if the call details are required to be retrieved. Some of the steps described above can be modified if the user selects the process of placing a collect call in the call type selection step, 2008 of FIG. 2.

FIGS. 3A-3D illustrate another method of establishing voice communication between a source and destination in one embodiment of the system. On selecting a method of placing a call, for example the user selects placing a collect call, as illustrated in step 3004c, the user is prompted to say his or her name and subsequently prompted to enter the destination number as illustrated in prompt user step, 3005 of FIG. 3A. The destination number is read or noted in note destination number step, 3008 and validated in validation step, 3009. Validating the destination number in step 3009 comprises accessing the positive and negative internal databases in the voice server 405 (or 505) and looking up the destination number in these databases. The negative and positive internal databases in the voice server 405 (or 505) comprise information gathered from call histories and can be updated whenever the destination number is verified using external databases. Validating the number in validation step, 3009 can comprise accessing the database comprising blocked numbers.

If the destination number is present either in the negative database or the blocked database then the number of times the user has attempted to enter the destination number is incremented by 1 and compared to the total number of attempts that the user is allowed as illustrated in check retry limit step, 3022. If the number of times the user has attempted to enter the destination number is less than the retry limit, then the process returns to prompt user step, 3005 and the user is prompted to enter destination number again. However, if the number of times the user has attempted to enter the destination number is equal to or greater than the retry limit, then an end message is played in step 3023 and the call is disconnected in call termination step, 3007.

If the validation step 3009 illustrates that the destination number is not present either in the negative database or in the blocked database, then the destination number is validated by accessing the V&H database provided by Bellcore or some other similar company that maintains and provides database comprising valid phone numbers and area codes as indicated in the V&H dip step 3010. If the destination number is not found in the V&H database, then an invalid number message is played as illustrated in step 3021. The process then returns to check retry limit step, 3022 and subsequently either to prompt user step, 3005 or call termination step, 3023. However, if the destination number is valid and found in the V&H database, then a local access transport area (LATA) flag is added to the call detail records (CDR) as illustrated in add LATA flag step, 3011. The LATA flag generally represents an area within which a divested Regional Bell operating company (RBOC) is permitted to offer exchange telecommunications and exchange access services. The LATA flag may allow identifying which RBOC provides service to the destination number. In dip internal block list step, 3012, the destination number is validated against an internal block list or database in the voice server 405 (or 505). Generally a destination number may be placed in the blocked list or database for any or all of the following reasons: requested to be placed on the block list by the receiver at the destination, the number of times a call has been placed to the destination number exceeds the maximum number of times a call can placed to any destination number in a given period or the dollar amount of the call placed to the destination number exceeds the maximum dollar amount of a call placed to any destination number in a given period. A destination number may be placed on the block list due to a court order or security reasons. If the destination number is present in the internal block list on the request of the receiver at the destination then a block message is played to the user as illustrated in step 3020 and the process proceeds to check retry limit step, 3022. If the destination number is placed on the block list for exceeding the maximum number of calls allowed or the maximum dollar amount that can be billed, then the process proceeds to start flow 2 step, 3025 of FIG. 3B. A call is placed to the destination number from the processing center 400 (or 500) as shown in 3026. When the call is answered a high toll block message is played as illustrated in play hi-toll block message step, 3028 and the connection is disconnected in step 3029. The process returns to step 3024 of FIG. 3A and a high toll block message is played to the user and the process proceeds to check retry limit step, 3022. In some instances, the destination number can be blocked by the competitive local exchange carrier (CLEC) for a variety of reasons. In this case, process proceeds to start flow 3 step, 3018 of FIG. 3C and a block message is played to the user in step 3030 and the process subsequently proceeds to check retry limit step, 3022 of FIG. 3A.

In the event that the destination number does not occur in the internal block list or database, the process proceeds to velocity dip step, 3014 wherein the number of attempts and/or connections made to a specific destination number is verified. If the number of attempts and/or connections made to a specific destination number is larger than the maximum number of attempts and/or connections allowed to that specific destination number for a particular duration (e.g., day or month) then the user is informed that the maximum number of attempts and/or connections allowed to that destination number is exceeded and the process proceeds to check retry limit step 3022.

If the number of attempts and/or connections made to a specific destination number is less than the maximum number of attempts and/or connections allowed to that specific destination number for a particular destination, then a counter related to the number of attempts and/or connections made to that destination number is incremented by 1 and the process proceeds to TNS dip step, 3015 wherein the destination number is validated for credit worthiness using a validation database provided by validation solution providers. If the credit worthiness of the destination number as dialed by the user is unverifiable, then the process proceeds to start flow 3 step 3018 of FIG. 3C and a block message is played to the user as illustrated in step 3030 and the process proceeds to check retry limit step 3022 of FIG. 3A. The destination number can be added to the internal blacklist for future reference.

However if in TNS dip step, 3015, the credit worthiness of the destination number as dialed is verified then the user is placed on hold as illustrated in step 3016 and the process proceeds to call to destination number step, 3032 of FIG. 3D. In the call to destination number step, 3032 of FIG. 3D, a call is placed to the destination number as dialed by the user by the application server 408 (or 508) through the IP gateway device 410 (or 510). When the call is answered by a receiver at the destination as illustrated in step 3033, a start message is played as shown in play start message step, 3034. The start message can include a custom greeting and the user's identity. In the event that the system is deployed in a correctional facility, the name of the facility can be included in the start message as illustrated in play facility name step, 3035. After the start message is played to the receiver at the destination, the receiver is provided with a list of options as illustrated in play options step, 3036. The list of options can comprise, for example a menu which allows the receiver to select between accepting the call and denying the call. In an embodiment, the receiver can be given the option to be added to a block list. The receiver at the destination can illustrate their selection which is transmitted back to the application server 408 (or 508) or the voice server 405 (or 505) as illustrated in record options step, 3037. If the receiver accepts the call then the application server can bridge the call to the user as illustrated in bridge to user step, 3038. In one embodiment, a message that parts or whole of the conversation is recorded may be played to the receiver and the voice server can record the conversation for future reference. In another embodiment, the receiver may be given the option to terminate the call if the receiver does not wish the conversation to be recorded. If the receiver denies the call then a message that call is rejected is played to the user as illustrated in step 3040 and the call is disconnected in step 3041. If the receiver selects the option to be added to the block list, then the application server 410 (or 510) can update the block list as illustrated in step 3039 and a message that call is rejected is played to the user as illustrated in step 3040 and the call is disconnected in step 3041. Some of the steps described above can be modified if the user selects to place a call using a debit card in the call type selection step 3004b.

For the voice communication system described in FIG. 1, in one embodiment, some of the administrative and service functions can be carried out remotely. The administrative and service functions can be performed over the internet using web interfaces 900 as shown in FIG. 1. Some of the administrative functions can include provisioning telephone adapter devices or switches, modifying route maps, updating databases and block lists, updating firewall settings, updating programs and software on the voice server, application server, firewall server, etc., performing routine maintenance on the gateway switches, IP router and other devices, upgrading firmware and software on the gateway switches, IP router and other devices, etc. The network administrator can log in to the application server located either in the network hub 401 or the network hub 501 to perform some of the administrative functions.

Some of the service functions can include creating users, updating account information for the different users, recharging user accounts, see past account details, listen to calls in progress, look-up the call history for any user, etc. The service functions can be performed either by a customer or a person in-charge at a facility where the service is provided. The customer or the administrator can open a web browser and type a web address that will direct the customer or the administrator to the web page from where service functions can be performed. For example, the customer or administrator may type “http://www.customteleconnect.com/” in the web browser. The customer or the administrator may type in any other web address as well. The web browser will direct the customer or the administrator to an example web page shown in FIG. 4. In other embodiments, the web page can have design, style and content that are substantially different from the web page shown in FIG. 4. The web page shown in FIG. 4 can have one or more areas that can be accessed interactively by the customer or the administrator, for example access tab 4001 and access tab 4002 in FIG. 4. The customer can interactively access the area illustrated by access tab 4001 which will direct the customer to another web page that will allow the customer to login with a user name and password. Similarly a administrator at a facility may interactively access the area illustrated by access tab 4002 and will be subsequently directed to a web page that will allow the administrator to login with a user name, password and an identification for the facility such as a facility name or a facility number.

FIG. 5 illustrates the menus and sub-menus that can be accessed by the customer or administrator to perform service functions. The menus and sub-menus can be a part of one or more web pages. The main menu 5001 and can provide a person accessing the main web page the option to either login as a customer or as an administrator at a facility. If the person selects the option to login as an administrator at a facility (e.g. by selecting access tab 4002), then the administrator is directed to a login sub-menu 5002. The login sub-menu 5002 can allow the administrator to enter a user name, a password and facility identification. The user name, password and the facility identification can be verified using an internal database in the application server 408 (or 508) or the voice server 405 (or 505). Upon validation the administrator at a facility is directed to an options sub-menu 5003. The options sub-menu 5003 can provide at least one or all of the following options: User Admin; Phone Control; PIN/PAN Control; Call Detail; Speed Dial; Investigation; Debit Cards; Trouble Reporting. The options sub-menu 5003 can provide additional options not listed above. Each option in the options sub-menu 5003 can direct the administrator to additional sub-menus illustrated by reference numbers 5004, 5005, 5006, 5008, 5009, 5010 and 5011. Additional sub-menus not shown in FIG. 5 can also be provided.

A phone control sub-menu 5004 is accessed when the administrator selects the Phone Control option in the options sub-menu 5003. The phone control sub-menu 5004 provides the option to change settings of one or more phones connected 101 to the telephone adapter devices. The phones can be turned on/off, speed call can be turned on/off, the time and date settings on the phones can be changed, etc. One embodiment of the phone control sub-menu is shown in FIG. 6. Referring to FIG. 5 again, the call detail sub-menu 5005 is accessed when the administrator selects the call detail option in the phone control sub-menu 5003. The call detail sub-menu 5005 can provide details about debit and collect calls among other details. The user admin sub-menu 5006 is accessed if the administrator selects the user admin option in the options sub-menu 5003. The user admin sub-menu 5006 can allow the administrator to add users, delete users and modify details about the existing users. Create user sub-menu 5006a illustrates a sub-menu that is available to the administrator to create new users. The create user sub-menu 5006a can allow the administrator to create a new user name and password. The create user sub-menu 5006a can allow input of additional information such as Email, Facility, PIN, personal access number (PAN), credit card and debit card information, etc. One embodiment of the user admin sub-menu 5006 is shown in FIG. 7.

With reference to FIG. 5, if the administrator selects PIN/PAN control in options sub-menu 5003, then the administrator is directed to a PIN/PAN control sub-menu 5008. The PIN/PAN control sub-menu 5008 can comprise additional sub-menus (e.g. PIN generating sub-menu 5008a and PIN administrative sub-menu 5008b. The PIN generating sub-menu 5008a allows generation of PINs either singly or in a batch. The PIN administrative sub-menu 5008b can allow administering existing PINs. Administering existing PINs can include one or more of the following options: send alerts to a specific destination number or email when a PIN associated with that email or destination number has activity, block certain destination numbers from receiving calls from a particular PIN, associate personal access number with destination numbers, associate a name with the PIN, etc. An embodiment of the PIN/PAN control sub-menu 5008 is shown in FIG. 8. Referring to FIG. 5, speed-dial sub-menu 5009 is accessed when the administrator selects the speed dial option in the options sub-menu 5003. The speed dial sub-menu 5009 can allow creating new speed dials and change existing speed dial settings. The debit card sub-menu 5010 is accessed when the debit card option is selected from the options sub-menu 5003. The debit card sub-menu 5010 can allow the administrator to order new debit cards, increment the dollar amount on a debit card, retrieve previous or existing debit card orders, etc. The investigation sub-menu 5011 is accessed when the option investigation in the options sub-menu 5003 is selected. The investigation sub-menu 5011 can provide the administrator to listen to call in progress, look-up destination numbers dialed, search calls made by a specific PIN, search calls made to a specific destination number, set alerts on PINS, etc. One embodiment of the investigation sub-menu 5011 is shown in FIG. 9.

If the person accessing the main web page selects the option to login as a customer (e.g. by accessing the access tab 4001), then the customer can be provided with similar menus and sub-menus as described above to manage his/her account. It should be noted that menus and sub-menus described above are only examples. Other menus and sub-menus providing different options can also be used to provide service functions to customers and administrators at facilities.

A wide variety of alternative system configurations are possible. For example, components and devices may be added, removed, or rearranged. Similarly a wide variety of alternative methods of performing administrative, service and control functions are possible. The order of the steps illustrated in placing the calls can be rearranged and modified. Alternate validation methods and techniques can be used other than those described herein. Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. A system for providing voice connection between a user at a source location and a destination, the system comprising:
a plurality of telephone adapter devices configured in a first local area network;
a plurality of voice communication devices in communication with said telephone adapter devices;
a router in communication with the first local area network and an IP network; and
a plurality of processing centers in communication with an IP network and a public switched telephone network,
wherein each of said plurality of processing centers comprises at least one server in communication with said plurality of voice communication devices over the IP network, and
wherein said at least one server can exchange information with the user at the correctional facility, process the information exchanged and based on the processing result, establish communication between the user and the destination.

2. The system of claim 1, wherein each of the plurality of processing centers further comprises a router in communication with said at least one server at a first end and the IP network at a second end.

3. The system of claim 1, wherein each of the plurality of processing centers further comprises a gateway switch in communication with said at least one server at a first end and the public switched telephone network at a second end.

4. The system of claim 1, wherein said at least one server is configured to remotely provision said plurality of telephone adapter devices

5. The system of claim 1, wherein said at least one server is adapted to validate incoming traffic.

6. The system of claim 1, wherein said at least one server is adapted to function as a web server to provide administrative and service functions.

7. The system of claim 1, wherein said at least one server is configured to store one or more validation databases.

8. The system of claim 1, wherein the plurality of processing centers is accessed and managed using a web interface.

9. The system of claim 1, wherein said at least one server is configured to record conversation between the user and the destination.

10. The system of claim 1, wherein the plurality of telephone adapter devices are provisioned remotely.

11. The system of claim 1, wherein the system is administered using a web interface.

12. The system of claim 1, wherein system is controlled using a web interface.

13. A method of providing voice communication from a user at a source location to a receiver at a destination, the method comprising:
providing at the source location a plurality of telephone adapter devices configured in a first local area network and a router, wherein said router is in communication with the plurality of telephone adapter devices at a first end and in communication with an IP network at a second end;
providing a plurality of processing centers in communication with an IP network, said plurality of processing centers comprising at least one server;
providing a plurality of voice communication devices in communication with the plurality of telephone adapter devices, wherein the plurality of telephone adapter devices convert signals from the voice communication devices into signals that can be transported over the IP network;
establishing communication between one of the voice communication devices and one of the plurality of processing centers by converting signals from the voice communication devices into signals that can be transported over the IP network and converting signals that can be transported over the IP network into signals that can be processed by the voice communication devices;
processing at said one of the plurality of processing centers, the information received from the voice communication devices; and
establishing communication between one of the said voice communication devices and the receiver at a destination through said one of the plurality of processing centers on the basis of the processing results.

14. The method of claim 13 further comprising:
transmitting a signal to one of the plurality of processing centers through the telephone adapter devices and the router when the user at the source location engages the voice communication device;
determining a port number and a phone number from the transmitted signal;
locating a database in said at least one server corresponding to the port number and the phone number;
sending a request from said one of the plurality of processing centers to the user at the source location to provide a first personal identification number; and
validating the first personal identification number provided by the user by accessing the database in said at least one server.

15. The method of claim 14 further comprising sending a request from said one of the plurality of processing centers to the user to select a method of billing.

16. The method of claim 15, wherein the method of billing comprises a debit card.

17. The method of claim 16, further comprising:
determining the number of available minutes;
communicating the number of available minutes available to the user;
requesting the user to provide a destination number, if number of available minutes available is greater than a round-off time;
validating the destination number in one or more internal and external databases;
sending a message to a receiver at the destination number; and
establishing connection between the user and the receiver at the destination.

18. The method of claim 17, wherein the round-off time is less than or equal to one minute.

19. The method of claim 15, wherein the method of billing comprises a collect call, wherein said collect call comprises billing a receiver at the destination.

20. The method of claim 17, wherein validating the destination number comprises querying said one or more internal and external databases if the destination number is associated with a switch-less service provider.

21. The method of claim 20, wherein the destination number is blocked if the destination number is associated with a switch-less service provider.

22. The method of claim 17, wherein validating the destination number comprises verifying the credit worthiness of the receiver at the destination number.

23. The method of claim 22, wherein the destination number is blocked if credit worthiness of the user at the destination number is not verified.

24. The method of claim 15, wherein the method of billing comprises using a credit card.

25. The method of claim 14 further comprising:
requesting the user to provide a second personal identification number if the first personal identification number is invalid; and
validating the second personal identification number provided by the user by accessing a database in said server.
